(19) United States
(12) Patent Application Publication
(10) Pub. No.: US 2026/0067962 A1
(43) Pub. Date: Mar. 5, 2026

(54) LINK MANAGEMENT FOR NON-COLLOCATED MULTI-LINK DEVICES

(71) Applicant: QUALCOMM Incorporated, San Diego, CA (US)

(72) Inventors: Gaurang NAIK, San Diego, CA (US); Abhishek Pramod PATIL, San Diego, CA (US); Sai Yiu Duncan HO, San Diego, CA (US); Giovanni CHISCI, San Diego, CA (US); Alfred ASTERJADHI, San Diego, CA (US); George CHERIAN, San Diego, CA (US); Sanket Sanjay KALAMKAR, San Diego, CA (US); Sherief HELWA, San Diego, CA (US)

(21) Appl. No.: 18/823,566

(22) Filed: Sep. 3, 2024

(51) Int. Cl. H04W 76/15; H04W 76/11

(52) U.S. Cl. CPC H04W 76/15; H04W 76/11

(57) ABSTRACT

This disclosure provides methods, components, devices and systems for link management for non-collocated (NC) multi-link devices (MLDs). Some aspects more specifically relate to techniques for MLD devices to exchange information specific to the links of one or more NC access point (AP) MLDs. The information exchange may be provided via extensions to a multi-link operation (MLO) framework to associate the link ID information for MLO with specific NC AP MLDs. Link information for NC AP MLDs may be provided via a NC link ID field that indicates one or more AP MLD IDs and one or more associated links, and an indication that the NC link ID is present in the communication. The NC link ID and indication may be provided, for example, in one or more fields or subfields of an (OMN) subframe, in a MLO link information element, or in an association frame or link reconfiguration request frame.

### TECHNICAL FIELD

This disclosure relates generally to wireless communication and, more specifically, to link management for non-collocated multi-link devices.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a wireless device. The method may include transmitting a first message that includes a non-collocated link identifier associated with the first message and an indication of a presence of the non-collocated link identifier, the non-collocated link identifier including a first identifier of a first access point (AP) multi-link device (MLD) and a first link identification that indicates a first link of a set of multiple different links associated with the first AP MLD, where the first AP MLD and at least a second AP MLD are each non-collocated AP MLDs and communicating with one or more of the first AP MLD or the second AP MLD based on the non-collocated link identifier included in the first message.

Another innovative aspect of the subject matter described in this disclosure can be implemented in a wireless device for wireless communications. The wireless device may include a processing system that includes processor circuitry and memory circuitry that stores code. The processing system may be configured to cause the wireless device to transmit a first message that includes a non-collocated link identifier associated with the first message and an indication of a presence of the non-collocated link identifier, the non-collocated link identifier including a first identifier of a first AP MLD and a first link identification that indicates a first link of a set of multiple different links associated with the first AP MLD, where the first AP MLD and at least a second AP MLD are each non-collocated AP MLDs and communicate with one or more of the first AP MLD or the second AP MLD based on the non-collocated link identifier included in the first message.

Another innovative aspect of the subject matter described in this disclosure can be implemented in a wireless device for wireless communications. The wireless device may include means for transmitting a first message that includes a non-collocated link identifier associated with the first message and an indication of a presence of the non-collocated link identifier, the non-collocated link identifier including a first identifier of a first AP MLD and a first link identification that indicates a first link of a set of multiple different links associated with the first AP MLD, where the first AP MLD and at least a second AP MLD are each non-collocated AP MLDs and means for communicating with one or more of the first AP MLD or the second AP MLD based on the non-collocated link identifier included in the first message.

Another innovative aspect of the subject matter described in this disclosure can be implemented in a non-transitory computer-readable medium storing code for wireless communications. The code may include instructions executable by one or more processors to transmit a first message that includes a non-collocated link identifier associated with the first message and an indication of a presence of the non-collocated link identifier, the non-collocated link identifier including a first identifier of a first AP MLD and a first link identification that indicates a first link of a set of multiple different links associated with the first AP MLD, where the first AP MLD and at least a second AP MLD are each non-collocated AP MLDs and communicate with one or more of the first AP MLD or the second AP MLD based on the non-collocated link identifier included in the first message.

In some examples of the method, wireless devices, and non-transitory computer-readable medium described herein, the non-collocated link identifier includes a first subfield that indicates the first identifier of the first AP MLD, and a second subfield that identifies at least the first link of the set of multiple different links associated with the first AP MLD. In some examples of the method, wireless devices, and non-transitory computer-readable medium described herein, the second subfield includes a bitmap that indicates one or more links of an AP MLD that is indicated in the first subfield. In some examples of the method, wireless devices, and non-transitory computer-readable medium described herein, the second subfield includes an indication of a single link of an AP MLD that is indicated in the first subfield.

In some examples of the method, wireless devices, and non-transitory computer-readable medium described herein, one or more non-collocated link identifiers may be included with the first message, and the first message further includes an indication of a quantity of the one or more non-collocated link identifiers.

In some examples of the method, wireless devices, and non-transitory computer-readable medium described herein, the first message may be an enhanced multi-link single radio (EMLSR) or an enhanced multi-link multi-radio (EMLMR) mode notification message, and the non-collocated link identifier may be included in an enhanced multi-link (EML) control subfield of the mode notification message. In some examples of the method, wireless devices, and non-transitory computer-readable medium described herein, EML control subfield includes a first subfield that indicates a presence of the non-collocated link identifier, and a second subfield that includes the non-collocated link identifier.

In some examples of the method, wireless devices, and non-transitory computer-readable medium described herein, the first message may be an EMLSR message or an EMLMR message, and the non-collocated link identifier may be included in an element in an enhanced multi-link notification frame. In some examples of the method, wireless devices, and non-transitory computer-readable medium described herein, the first message may be a cross-link tunneling message, and the non-collocated link identifier may be included in a multi-link operation (MLO) link information element. In some examples of the method, wireless devices, and non-transitory computer-readable medium described herein, the first message may be a basic multi-link element associated with a non-simultaneous transmit and receive (NSTR) link, and the non-collocated link identifier may be included in a station (STA) information subfield of the multi-link element.

In some examples of the method, wireless devices, and non-transitory computer-readable medium described herein, the first message may be a traffic indication message associated with the wireless device, and where the non-collocated link identifier may be included in a traffic indication message element in a beacon frame, a beacon extension frame, or a management frame. In some examples of the method, wireless devices, and non-transitory computer-readable medium described herein, the first message may be a target wake time session setup or transfer message, and where the non-collocated link identifier may be included in a target wake time element. In some examples of the method, wireless devices, and non-transitory computer-readable medium described herein, the first message may be a power save indication message associated with the wireless device, and where the non-collocated link identifier may be included in an aggregate control field of the power save indication message.

Another innovative aspect of the subject matter described in this disclosure can be implemented in a method for wireless communications by a first AP MLD. The method may include transmitting, to one or more non-AP MLDs, one or more identifiers for one or more non-collocated AP MLDs, receiving, from a first non-AP MLD of the one or more non-AP MLDs, a first message that includes a non-collocated link identifier associated with the first message and an indication of a presence of the non-collocated link identifier, the non-collocated link identifier including a first identifier of a second AP MLD and a first link identification that indicates a first link of a set of multiple different links associated with the second AP MLD, where the first AP MLD and the second AP MLD are each one of the one or more non-collocated AP MLDs, and communicating with the second AP MLD based on the non-collocated link identifier included in the first message.

Another innovative aspect of the subject matter described in this disclosure can be implemented in a first AP MLD for wireless communications. The first AP MLD may include a processing system that includes processor circuitry and memory circuitry that stores code. The processing system may be configured to cause the first AP MLD to transmit, to one or more non-AP MLDs, one or more identifiers for one or more non-collocated AP MLDs, receive, from a first non-AP MLD of the one or more non-AP MLDs, a first message that includes a non-collocated link identifier associated with the first message and an indication of a presence of the non-collocated link identifier, the non-collocated link identifier including a first identifier of a second AP MLD and a first link identification that indicates a first link of a set of multiple different links associated with the second AP MLD, where the first AP MLD and the second AP MLD are each one of the one or more non-collocated AP MLDs, and communicate with the second AP MLD based on the non-collocated link identifier included in the first message.

Another innovative aspect of the subject matter described in this disclosure can be implemented in a first AP MLD for wireless communications. The first AP MLD may include means for transmitting, to one or more non-AP MLDs, one or more identifiers for one or more non-collocated AP MLDs, means for receiving, from a first non-AP MLD of the one or more non-AP MLDs, a first message that includes a non-collocated link identifier associated with the first message and an indication of a presence of the non-collocated link identifier, the non-collocated link identifier including a first identifier of a second AP MLD and a first link identification that indicates a first link of a set of multiple different links associated with the second AP MLD, where the first AP MLD and the second AP MLD are each one of the one or more non-collocated AP MLDs, and means for communicating with the second AP MLD based on the non-collocated link identifier included in the first message.

Another innovative aspect of the subject matter described in this disclosure can be implemented in a non-transitory computer-readable medium storing code for wireless communications. The code may include instructions executable by one or more processors to transmit, to one or more non-AP MLDs, one or more identifiers for one or more non-collocated AP MLDs, receive, from a first non-AP MLD of the one or more non-AP MLDs, a first message that includes a non-collocated link identifier associated with the first message and an indication of a presence of the non-collocated link identifier, the non-collocated link identifier including a first identifier of a second AP MLD and a first link identification that indicates a first link of a set of multiple different links associated with the second AP MLD, where the first AP MLD and the second AP MLD are each one of the one or more non-collocated AP MLDs, and communicate with the second AP MLD based on the non-collocated link identifier included in the first message.

In some examples of the method, first AP MLDs, and non-transitory computer-readable medium described herein, the non-collocated link identifier includes a first subfield that indicates the first identifier of the second AP MLD, and a second subfield that identifies at least the first link of the set of multiple different links associated with the second AP MLD.

In some examples of the method, first AP MLDs, and non-transitory computer-readable medium described herein, the first message may be an EMLSR or an EMLMR mode notification message, and the non-collocated link identifier may be included in an EML control subfield of the mode notification message. In some examples of the method, first AP MLDs, and non-transitory computer-readable medium described herein, the EML control subfield includes a first subfield that indicates a presence of the non-collocated link identifier, and a second subfield that includes the non-collocated link identifier. In some examples of the method, first AP MLDs, and non-transitory computer-readable medium described herein, the first message may be an EMLSR message or an EMLMR message, and the non-collocated link identifier may be included in an element in an enhanced multi-link notification frame. In some examples of the method, first AP MLDs, and non-transitory computer-readable medium described herein, the first message may be a cross-link tunneling message, and the non-collocated link identifier may be included in a MLO link information element. In some examples of the method, first AP MLDs, and non-transitory computer-readable medium described herein, the first message may be a cross-link tunneling message, and the non-collocated link identifier may be included in an information element that is different from a MLO link information element.

In some examples of the method, first AP MLDs, and non-transitory computer-readable medium described herein, the first message may be a traffic indication message associated with the first non-AP MLD, and where the non-collocated link identifier may be included in a traffic indication message element in a beacon frame, a beacon extension frame, or a management frame. In some examples of the method, first AP MLDs, and non-transitory computer-readable medium described herein, the first message may be a target wake time session setup or transfer message, and where the non-collocated link identifier may be included in a target wake time element. In some examples of the method, first AP MLDs, and non-transitory computer-readable medium described herein, the first message may be a power save indication message associated with the first non-AP MLD, and where the non-collocated link identifier may be included in an aggregate control field of the power save indication message.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example of a wireless communication network with non-collocated multi-link devices that supports link management for non-collocated multi-link devices.

FIG. 4 shows an example of a enhanced multi-link control subfield that supports link management for non-collocated multi-link devices.

FIG. 5 shows an example of a non-collocated link ID list that supports link management for non-collocated multi-link devices.

FIG. 6 shows an example of an enhanced multi-link operating mode notification frame that supports link management for non-collocated multi-link devices.

FIGS. 7A through 7C show examples of multi-link operation link information elements that support link management for non-collocated multi-link devices.

FIG. 8 shows an example of a multi-link element that supports link management for non-collocated multi-link devices.

FIG. 9 shows a block diagram of an example wireless communication device that supports link management for non-collocated multi-link devices.

FIG. 10 shows a block diagram of an example wireless communication device that supports link management for non-collocated multi-link devices.

FIG. 11 shows a flowchart illustrating an example process performable by or at a wireless device that supports link management for non-collocated multi-link devices.

FIG. 12 shows a flowchart illustrating an example process performable by or at a first access point (AP) multi-link device (MLD) that supports link management for non-collocated multi-link devices.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a non-access point (AP) device (such as a non-AP station (STA) or a non-AP multi-link device (MLD) with one or more affiliated non-AP STAs) may communicate with multiple AP MLDs in accordance with multi-link operation (MLO) techniques. MLO techniques may provide that a non-AP MLD will manage links with multiple AP MLDs. In some wireless communication networks, one or more of the multiple AP MLDs may be non-collocated (NC) with other of the AP MLDs. In such examples, the non-AP devices and AP MLDs may need to manage links associated with NC AP MLDs.

Various aspects relate generally to methods for devices, such as non-AP MLDs and NC AP MLDs, to manage links with NC AP MLDs. Various aspects relate more specifically to techniques for MLD devices to exchange information specific to the links of one or more NC AP MLDs. In some aspects, extensions to a MLO framework may be provided to associate the link ID information for multi-link operation with specific NC AP MLDs. For example, an enhanced multi-link (EML) control subfield of an EML operating mode notification (OMN) subframe may include a NC link ID field that indicates one or more AP MLD IDs and one or more associated links, and an indication that the NC link ID is present in the EML OMN frame. In other examples, a NC link ID element may be included as a separate element in an EML OMN frame, such as an element outside the EML control field. In further examples, a NC link ID may be included in a MLO link information element that may indicate that the information carried in the frame carrying the MLO link information element is applicable to links of one or more NC AP MLDs. In still further examples, a device may indicate a link status in a NC link ID subfield on an association frame or link reconfiguration request frame, such as via a basic or reconfiguration multi-link element. In some further examples, the NC link ID subfield may be included in a target wake time (TWT) element that may set up TWT sessions with one or more NC AP MLDs. In some further examples, the NC link ID subfield may be included in an aggregate control (A-Control) subfield that may indicate the power save status (such as an active mode or a power save mode) on links established across NC AP MLDs. In some further examples, the NC link ID subfield may be included in a frame that may indicate buffered traffic indication for the non-AP MLD at the one or more links of the one or more NC AP MLDs.

Particular aspects of the subject matter described in this disclosure may be implemented to realize one or more of the following potential advantages. The techniques employed by the described communication devices may provide benefits and enhancements to the operation of the communication devices, including increased efficiency associated with access with NC AP MLDs. For example, operations performed by the described communication devices may provide improvements to multi-link access techniques by enabling a non-AP device, or an AP device, to identify one or more links associated with NC AP MLDs for management of the links, which may reduce latency as a result of providing uninterrupted service and efficient roaming, enhance reliability as a result of providing link status, and enhance user experience.

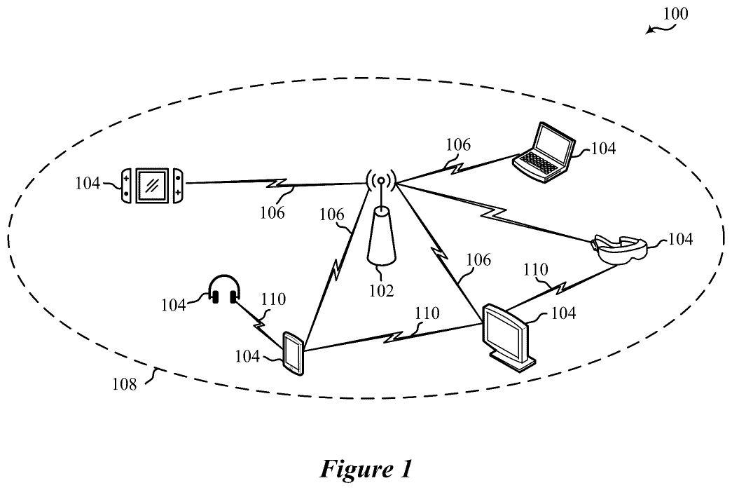

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHZ-24.25 GHZ), FR4a or FR4-1 (52.6 GHz-71 GHZ), FR4 (52.6 GHz-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

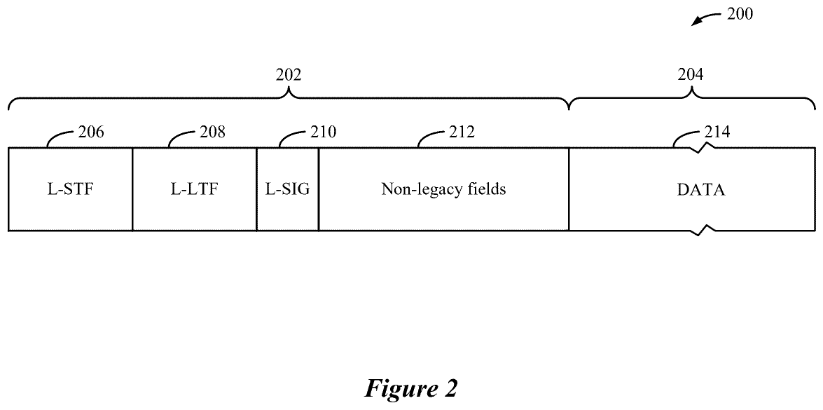

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHZ band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner. In contrast, some MLSR MLDs may further be capable of an enhanced MLSR (EMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the EMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHZ band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLO may increase the number of users per multiplexed transmission served by the multi-link AP MLD.

Techniques described herein may enable wireless devices, such as non-AP MLDs and AP MLDs to provide link information for NC AP MLDs that may be used by the wireless devices. In some aspects, extensions to a MLO framework may be provided to associate the link ID information for multi-link operation with specific NC AP MLDs. For example, an EML control subfield of an EML OMN subframe may include a NC link ID field that indicates one or more AP MLD IDs and one or more associated links, and an indication that the NC link ID is present in the EML OMN frame. In other examples, a NC link ID element may be included as a separate element in an EML OMN frame, such as an element outside the EML control field. In further examples, a NC link ID may be included in a MLO link information element that may indicate links of one or more NC AP MLDs. In still further examples, a device may indicate a link status in a NC link ID subfield on an association frame or link reconfiguration request frame, such as via a basic or reconfiguration multi-link element. In some further examples, the NC link ID subfield may be included in a TWT element that may set up TWT sessions with one or more NC AP MLDs. In some further examples, the NC link ID subfield may be included in an A-Control subfield that may indicate the power save status (such as an active mode or a power save mode) on links established across NC AP MLDs. In some further examples, the NC link ID subfield may be included in a frame that may indicate buffered traffic indication for the non-AP MLD at the one or more links of the one or more NC AP MLDs. The NC link ID may include, for example, an identifier of an AP MLD, and a link ID for one or more links of the identified AP MLD. For example, such a link ID may be provided as a bitmap in which each bit in the bitmap indicates an associated link of the identified AP MLD. In other examples, instead of a bitmap the link ID may provide an indication of a single link (for example, a 4-bit field may provide a link ID of the AP MLD).

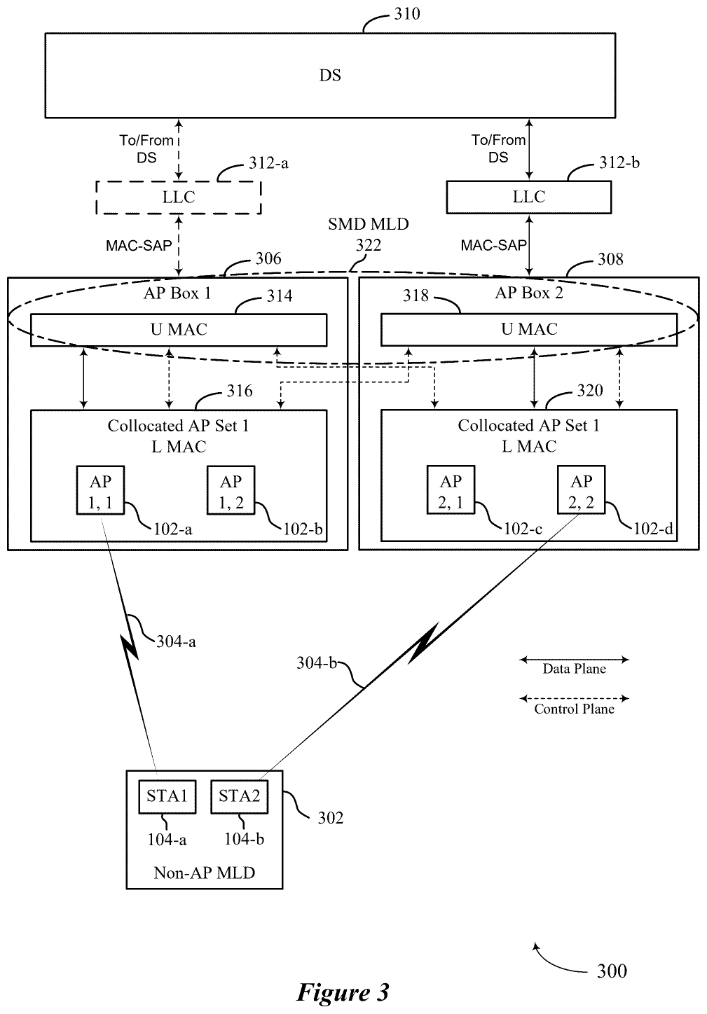

FIG. 3 shows an example of a wireless communication network 300 with non-collocated MLDs that supports link management for non-collocated multi-link devices. The wireless communication network 300 with non-collocated MLDs may implement or may be implemented by aspects of the wireless communication network 100 or the PPDU 200. For example, the wireless communication network 300 with non-collocated MLDs may include a non-AP device 302 (such as a wireless device, one or more non-AP STAs 104, a non-AP MLD) and one or more APs 102 (such as AP STAs, an AP MLDs), which may be examples of the corresponding devices as described with reference to FIG. 1. In some examples, the non-AP device 302 may obtain a candidate AP mobility set (CAMS) (such as a candidate AP MLD set) for performing seamless roaming. As described herein, roaming may refer to a distribution system (DS) mapping change of the non-AP device from a former serving AP to a target AP. In other examples, non-AP device 302 may be able to perform actions like setup (or negotiation of) TWT, traffic identifier (TID)-to-Link mapping, multi-link reconfiguration, and manage operating modes (such as EMLSR/NSTR) with NC AP MLDs or obtain an indication of buffered traffic at the NC AP MLDs.

In some aspects, the wireless communication network 300 with non-collocated MLDs may include a DS 310, which may communicate using multiple AP boxes that are non-collocated, including a first AP box 306 and a second AP box 308. In this example, the first AP box 306 includes a first collocated AP set 316 that includes multiple collocated APs, such as a first AP 102-a and a second AP 102-b. Likewise, the second AP box 308 includes a second collocated AP set 320 that includes multiple collocated APs, such as a third AP 102-c and a fourth AP 102-d. As discussed, the first AP box 306 and the second AP box 308 in this example are non-collocated, and thus the first AP 102-a and the second AP 102-b are non-collocated with the third AP 102-c and the fourth AP 102-d. The first AP box 306 includes a first unified upper MAC (U-MAC) 314 and the second AP box 308 includes an associated second U-MAC 318 that provide communications with the DS 310 via logical link control (LLC) 312, including first LLC 312-a and second LLC 312-b, respectively. The first U-MAC 314 and the second U-MAC 318 may provide a seamless mobility domain (SMD) entity, such as SMD MLD 322, which may be a logical entity that controls the associated non-collocated APs 102.

As described herein, MLO techniques may be implemented using NC AP MLDs, such as to provide seamless roaming that may enable relatively faster roaming of a non-AP device 302 (such as a non-AP MLD, a first non-AP STA 104-a, or a second non-AP STA 104-b) between NC AP MLDs (such as first AP 102-a and fourth AP 102-d via first link 304-a and second link 304-b, respectively), and may reduce time associated with re-association and re-authentication for roaming. APs 102 of the SMD MLD 322 (such as first AP 102-a, which may be a serving AP, a fourth AP 102-d, which may be a target AP) may operate cooperatively by transmitting signaling over the air or over DS 310. Accordingly, the non-AP device 302 may associate with and maintain association and authentication context with the NC AP MLDs.

In examples in which the non-AP device 302 performs seamless roaming, such seamless roaming techniques may involve a transitionary phase where a client is connected to two NC AP MLDs. Before this phase the non-AP device 302 is connected only to serving AP MLD (such as, first AP 102-a), and after this phase, the non-AP device 302 is connected only to the target AP MLD (such as, fourth AP 102-d). Being “connected” implies AP MLD and non-AP MLD can exchange frames with each other. During the transition phase, the non-AP MLD might need to manage links across two NC AP MLDs. For example, a single radio non-AP MLD might want to add two links in EMLSR mode (one with serving AP MLD and another with target AP MLD). In another example, a multi-radio non-AP MLD might establish one link each with the two NC AP MLDs, but these links may be NSTR or the non-AP MLD might want to add two links (one with serving AP MLD and another with target AP MLD) in the EMLMR mode. During the transition phase, the non-AP MLD might setup an individual TWT session with the target AP MLD and/or might tunnel frames to links of the target AP MLD by sending these frames to the serving AP MLD, or vice versa. In accordance with various techniques discussed herein, link management across NC MLDs may be provided through identification of the target NC AP MLD (such as fourth AP 102-d), such as based on AP MLD ID that may be assigned by the serving AP (such as first AP 102-a) or the SMD to the target NC AP MLD. In other examples, the target NC AP MLD may be identified via the MLD MAC address of the NC AP MLD. Further, identification of the links with reference to the target AP MLD may be provided.

In some aspects, techniques discussed herein may be used where a non-AP can be served concurrently by different NC AP MLDs. For example, an EMLSR non-AP MLD might want to setup one link each with two different NC AP MLDs. Similarly, a non-AP MLD with three radios might setup one link with one AP MLD and two links with another AP MLD. Once setup, the NC AP MLDs and non-AP MLD can exchange frames on any of these links. In some examples, non-AP device 302 may transmit one or more messages with a NC link ID to indicate information for a link of a NC AP MLD. In other examples, a NC AP MLD may use a NC link ID to provide information to another device related to a different NC AP MLD, such as an AP MLD that might include a traffic indication on behalf of a NC AP MLD. For example, say the non-AP MLD is actively communicating with two NC AP MLDs and it is in power save mode with the second of the two NC AP MLDs. The first NC AP MLD might indicate to the non-AP MLD that the second NC AP MLD has buffered traffic for the non-AP MLD. Such an indication might be provided by the target AP MLD, the serving AP MLD, or both. The information may be provided via an identifier of the second AP MLD and an identifier of the link of that second AP MLD, but the direction of communication changes relative to such information that is provided by a non-AP MLD. Techniques as discussed herein may be used in link management in such situations.

In some examples, a traffic indication message may be used to provide the information for the NC link of an NC AP MLD. For example, a traffic indication message may be a message through which an AP MLD (such as AP 102-a) indicates to the non-AP device 302 on the first link 304-a that there is pending traffic on another link (such as the second link 304-b). A cross-link traffic indication may be used to provide such an indication. In some examples, such a traffic indication message may be used when the non-AP device 302 is roaming from one AP MLD (such as the first AP 102-a that may be a serving AP MLD) to another AP MLD (such as the fourth AP 102-d that may be a target AP MLD). In other examples, such a traffic indication message may be used when a non-AP device 302 is concurrently served by two NC AP MLDs. In the roaming case, such a situation may occur during the transitory phase when the non-AP device 302 is roaming from a second AP MLD to a first AP MLD. Such a situation may also occur if non-collocated simultaneous serving is allowed. In some examples, the message with the NC link ID may be a traffic indication message associated with the non-AP device 302, and the NC link ID may be included in a traffic indication message element in a beacon frame, or a beacon extension frame, or a management frame. In some examples, message with the NC link ID may be a target wake time (TWT) session setup or transfer message, and the NC link ID may be included in a target wake time element. In further examples, the message with the NC link ID may be a power save indication message associated with the non-AP device 302. For example, the non-AP MLD might want to enter into a power save mode on one or more links of the serving AP MLD while entering into an active mode on one or more links of the target AP MLD. In such examples, the NC link ID may be included in an aggregate control field, or another field, of the power save indication message sent by the non-AP MLD to the target AP MLD.

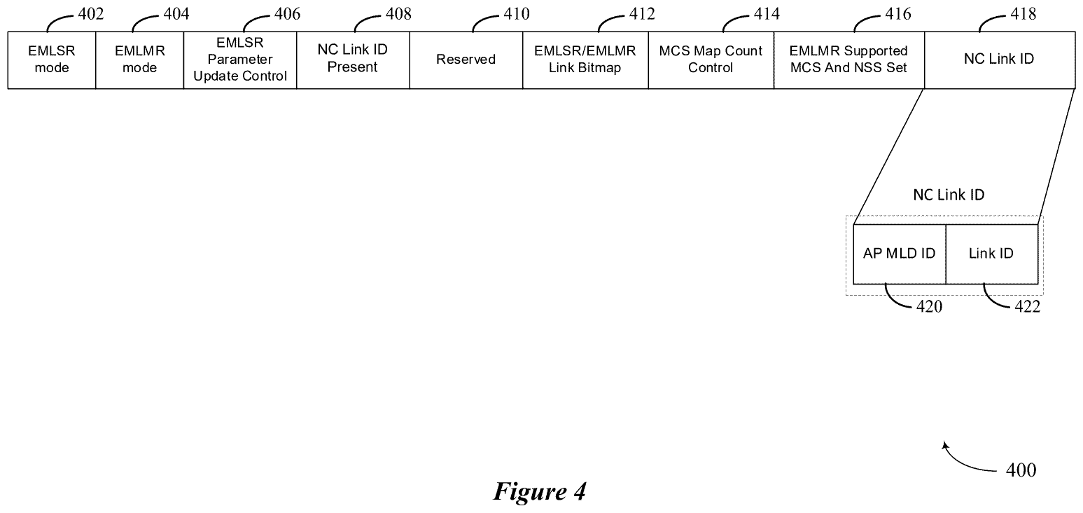

FIGS. 4 through 8 illustrate some examples of identification of a target NC AP MLD, and identification of the link(s) with reference to the target NC AP MLD.

FIG. 4 shows an example of an enhanced multi-link (EML) control subfield 400 that supports link management for non-collocated multi-link devices. The EML control subfield 400 may implement or may be implemented by aspects of the wireless communication network 100, the PPDU 200, or the wireless communication network 300. For example, the EML control subfield 400 may be implemented by a non-AP device (such as a wireless device, a non-AP STA, a non-AP MLD) and one or more APs (such as AP MLDs in a DS, an AP STA, an AP MLD), which may be examples of the corresponding devices as described with reference to FIGS. 1 and 3.

In this example, EMLSR links may be present across NC AP MLDs, and an EML control subfield 400 may be extended to include the AP MLD ID of the NC AP MLD. For example, the EML control subfield 400 may include a ELMSR mode field 402, an EMLMR mode field 404, an EMLSR parameter update control field 406, a NC link ID present field 408 that may provide an indication that a NC link ID field 418 is present in the EML control subfield 400, a reserved field 410, an EMLSR/EMLMR link bitmap field 412, a MCS map count control field 414, and an EMLMR supported MCS and NSS set field 416. In this example, the NC link ID field 418 may include an AP MLD ID 420 that indicates the NC AP MLD that as associated with the message, and a link ID field 422 that indicates one or more particular links at the identified NC AP MLD.

In some aspects, a non-AP MLD may send an EML OMN frame to an AP MLD that includes the EML control subfield 400. The EML control subfield 400 may be transmitted to a serving AP MLD, and in some instances may also be transmitted to a target AP MLD. When sent to a serving AP MLD, the AP MLD ID of the NC AP MLD may be provided in accordance with an ID assigned by the serving AP or the SMD. When sent directly to the NC AP MLD, the AP MLD ID may be set to 0 when referring to links of the NC AP MLD (i.e., the serving AP MLD). To indicate zero or more link(s) of the recipient AP MLD as EMLSR link(s), the non-AP MLD may set the corresponding bits to 1. To indicate one or more link(s) of a NC AP MLD as EMLSR link(s), the non-AP MLD may include a NC Link ID Bitmap in the link ID field 422. In some aspects, the NC link ID field 418 may be appended at the end of the EML control subfield 400 (of the EML OMN frame) as shown in FIG. 4, its corresponding presence bit is provided in the NC link ID present field 408. It is noted that this framework may allow the non-AP MLD to enter into EMLSR mode on links of the target AP MLD without including any link with the serving AP MLD as EMLSR links.

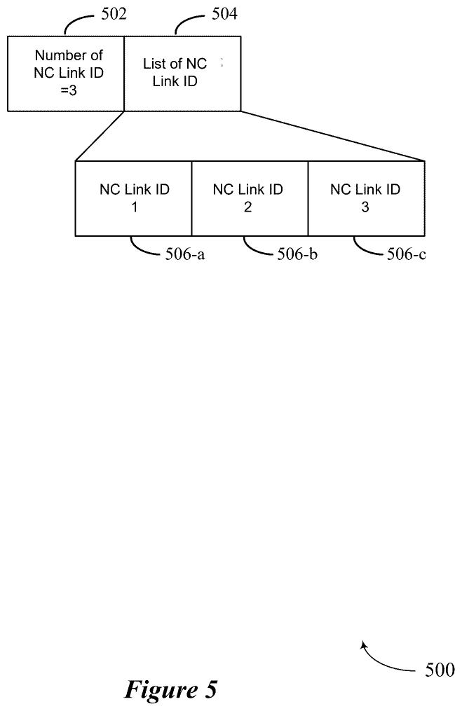

For example, in the case where a non-AP MLD moves from a serving AP MLD to a target AP MLD, and the serving AP has assigned target AP MLD an AP MLD ID of 56, the NC link ID field 418 may include a value of 56 as the AP MLD ID 420. As the non-AP MLD moves, it sends an EML OMN frame to the serving AP MLD to enter the EMLSR mode on link ID 0 of serving AP MLD and link ID 3 of target AP MLD, which may be indicated in link ID field 422. In such an example, the NC link ID present field 418 may be set to indicate the presence of NC link ID field 418 (such as by setting a bit of the field to 1). In some examples, the bit position 0 is set to 1 in the EMLSR/EMLMR link bitmap field 412 to indicate link ID 0 of the serving AP MLD (the recipient AP MLD) as one of the EMLSR links. Further, the NC Link ID field 418 is present, and the AP MLD ID 420 is set to 56 to indicate the AP MLD ID of the target AP MLD and the link ID field 422 includes a bitmap with bit position 3 is set to 1 to indicate link ID 3 of the target AP MLD as one of the EMLSR links. In some examples, instead of a bitmap the link ID may provide an indication of a single link (for example, a 4-bit field may provide a link ID of the NC AP MLD). In some examples, instead of including a single NC link ID field 418, an NC link ID list field may be defined, where the first subfield indicates a quantity of NC link ID subfields present in the NC link ID list field. For example, if the non-AP MLD wants to establish EMLSR links across four NC AP MLDs including the recipient AP MLD, it may include the NC link ID list with the quantity of NC link ID value set to 3 (corresponding to the three link IDs other than a link of the serving AP). FIG. 5 shows an example non-collocated link ID list field.

FIG. 5 shows an example of a non-collocated link ID list field 500 that supports link management for non-collocated multi-link devices. The non-collocated link ID list field 500 may implement or may be implemented by aspects of the wireless communication network 100, the PPDU 200, or the wireless communication network 300. For example, the non-collocated link ID list field 500 may be implemented by a non-AP device (such as a wireless device, a non-AP STA, a non-AP MLD) and one or more APs (such as AP MLDs in a DS, an AP STA, an AP MLD), which may be examples of the corresponding devices as described with reference to FIGS. 1 and 3.

In this example, the non-collocated link ID list field 500 may replace the NC link ID field 418 of FIG. 4, and may include a quantity of links field 502 and a list of NC link IDs field 504. Further, the NC link IDs field 504 may include NC link IDs 506 (which each may correspond to a NC link ID field 418), where a quantity of NC link IDs 506 corresponds to a quantity of links indicated in the quantity of links field 502. Each NC link ID 506 may include an associated AP MLD ID in a first field and an identifier of associated links (such as a bitmap, as discussed above). In the example of FIG. 5, the non-AP MLD wants to establish EMLSR links across four NC AP MLDs including the recipient AP MLD, and thus includes the NC link ID list with the quantity of NC link ID value set to 3 (corresponding to the three link IDs other than a link of the serving AP), and three corresponding NC link IDs 506, including first NC link ID 506-a, second NC link ID 506-b, and third NC link ID 506-c. It is to be understood that three link IDs are shown for purposes of discussion and illustration, and that any number of links may be indicated in accordance with such techniques.

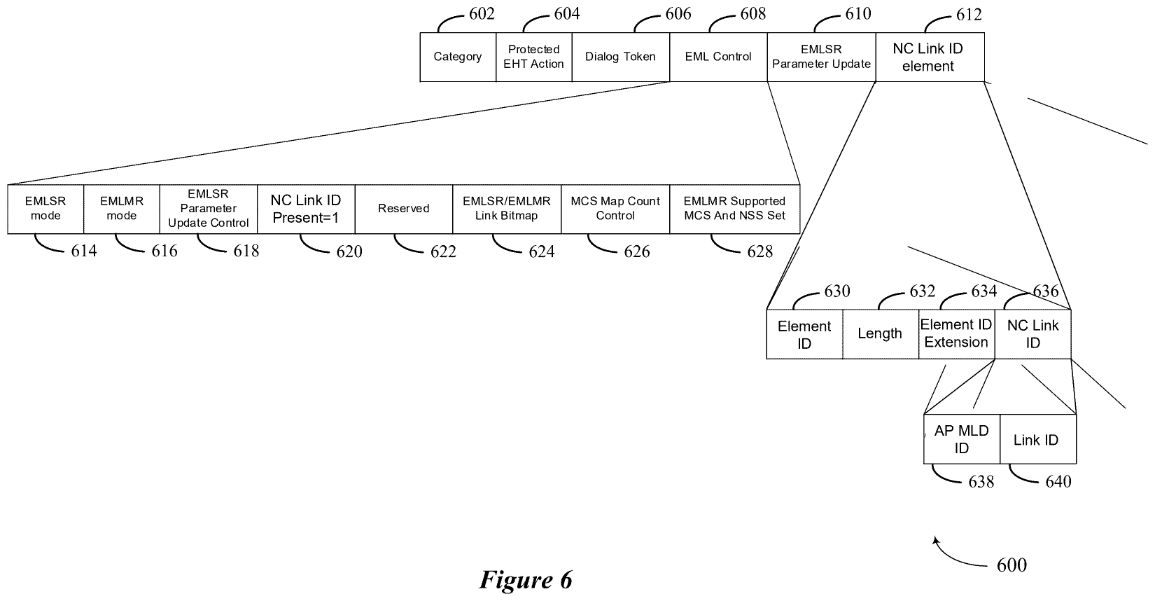

FIG. 6 shows an example of an EML OMN frame 600 that supports link management for non-collocated multi-link devices. The EML OMN frame 600 may implement or may be implemented by aspects of the wireless communication network 100, the PPDU 200, or the wireless communication network 300. For example, the EML OMN frame 600 may be implemented by a non-AP device (such as a wireless device, a non-AP STA, a non-AP MLD) and one or more APs (such as AP MLDs in a DS, an AP STA, an AP MLD), which may be examples of the corresponding devices as described with reference to FIGS. 1 and 3.

In this example, the EML OMN frame 600 may include a number of fields, including category field 602, protected EHT action field 604, dialog token field 606, EML control field 608, ELMSR parameter update field 610, and NC link ID element 612. In this example, the information of the NC AP MLD is included in the separate NC link ID element 612 in the EML OMN frame 600. Further, the EML control field 608 in this example may include a ELMSR mode field 614, an EMLMR mode field 616, an EMLSR parameter update control field 618, a NC link ID present field 620 that may provide an indication that the NC link ID element 612 is present in the EML OMN frame 600, a reserved field 622, an EMLSR/EMLMR link bitmap field 624, a MCS map count control field 626, and an EMLMR supported MCS and NSS set field 628. In this example, the NC link ID element 612 may include an element ID 630, a length field 632, and element ID extension 634, and a NC link ID field 636. Similarly as discussed above, the NC link ID field 636 may include AP MLD ID field 638 and a link ID field 640.

Thus, in this example, instead of including the NC link ID field as the last subfield of the EML Control field (such as discussed with reference to FIG. 4), it can be wrapped in an element (such as, NC link ID element 612) which appears at the end of the EML frame. To indicate to the recipient AP MLD that the NC link ID element 612 appears at the end of the EML OMN frame 600, in some examples the NC link ID present field 620 may be defined. In some examples, the NC link ID present field 620 is not required. In some examples, if the non-AP MLD intends to enter into EMLSR mode with EMLSR links for more than two NC AP MLDs, then for each NC AP MLD other than the recipient AP MLD, a separate NC Link ID element may be inserted.

Although the above examples are described with respect to the EMLSR mode, they may also be applicable to other modes of operation between the non-AP MLD and the NC AP MLDs. For example, the non-AP MLD might enable or disable EMLMR links across the NC AP MLDs. Similarly, the non-AP MLD might enable or disable the multi-link dynamic spatial multiplexing power save mode with two or more links established across NC AP MLDs. Even though the exact frames sent by the non-AP MLD to the serving (or the target) AP MLD may be different, the frame may generally indicate the link(s) of the NC AP MLDs via the NC link ID subfield.

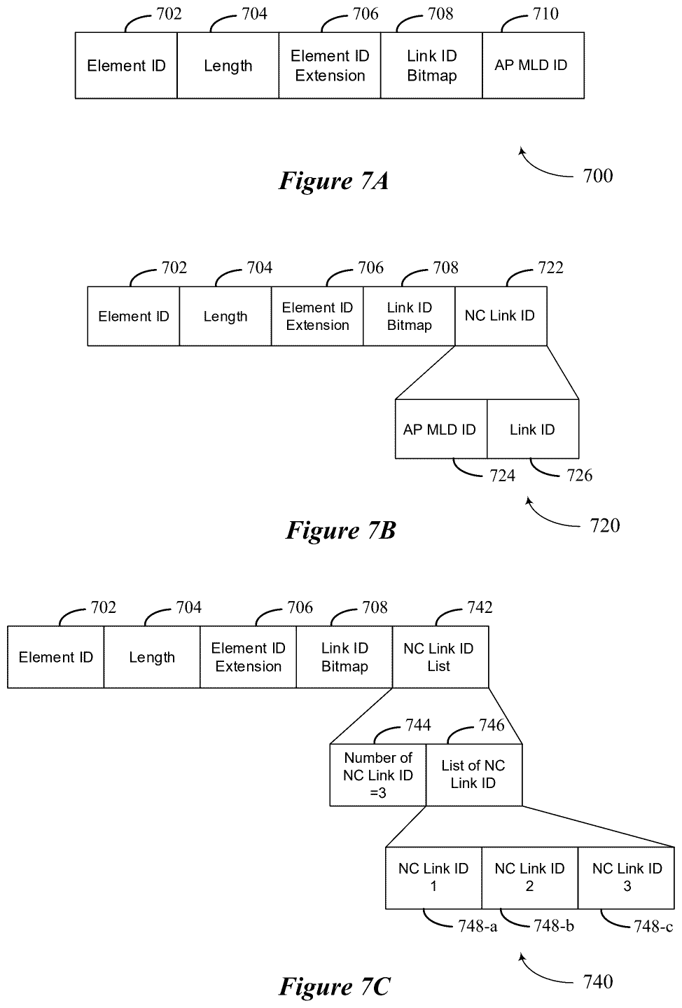

FIGS. 7A through 7C show examples of MLO link information elements 700, 720, and 740 that support link management for non-collocated multi-link devices. The MLO link information elements 700, 720, and 740 may implement or may be implemented by aspects of the wireless communication network 100, the PPDU 200, or the wireless communication network 300. For example, the MLO link information elements 700, 720, and 740 may be implemented by a non-AP device (such as a wireless device, a non-AP STA, a non-AP MLD) and one or more APs (such as AP MLDs in a DS, an AP STA, an AP MLD), which may be examples of the corresponding devices as described with reference to FIGS. 1 and 3.

In this example, MLO link information elements 700, 720, and 740 may be used with cross link tunneling for NC AP MLDs. In a first example shown in FIG. 7A, MLO link information element 700 may include an element ID field 702, a length field 704, an element ID extension field 706, a link ID bitmap field 708, and an AP MLD ID field 710. Thus, in this example, an existing extensible format of the MLO link information element may be extended to include the AP MLD ID field 710. In such examples, when the non-AP MLD sends a frame that is intended for a link of an NC AP MLD, it includes the AP MLD ID field 710 in the MLO link information element 700. When present, the contents of the frame are applicable to all links of the NC AP MLD (given by the AP MLD ID) whose corresponding bits are set to 1 in the link ID bitmap field 708. In some examples, the MLO link information element 700 may be used when the contents of the frame are meant only for one AP MLD (such as either the serving AP MLD or the target AP MLD, but not both).

The solution can be generalized to indicate links of the serving as well as target AP MLD, as illustrated in FIG. 7B. In this example, MLO link information element 720 may include an element ID field 702, a length field 704, an element ID extension field 706, a link ID bitmap field 708, and a NC link ID field 722. The NC link ID field 722, similarly as discussed above, may include an AP MLD ID field 724 and a link ID field 726. In this case, the link ID bitmap field 708 may indicate link(s) of the recipient AP MLD to which the content applies, and the link ID field 726 of the NC link ID field 722 may indicate the link(s) of the NC AP MLD identified by the AP MLD ID field 724.

The solution can be further generalized to indicate information for an arbitrary number of NC AP MLDs, as illustrated in FIG. 7C. In this example, MLO link information element 740 may include an element ID field 702, a length field 704, an element ID extension field 706, a link ID bitmap field 708, and a NC link ID list 742. The NC link ID list 742, may include a quantity of links field 744 and a list of NC link IDs field 746. Further, the NC link IDs field 746 may include NC link IDs 748 (which each may correspond to a NC link ID field 418 or NC link ID field 722), where a quantity of NC link IDs corresponds to a quantity of links indicated in the quantity of links field 744. Each NC link ID 748 may include an associated AP MLD ID in a first field and an identifier of associated links (such as a bitmap, as discussed above). In the example of FIG. 7C, the non-AP MLD wants to establish EMLSR links across four NC AP MLDs including the recipient AP MLD, and thus includes the NC link ID list with the quantity of NC link ID value set to 3 (corresponding to the three link IDs other than a link of the serving AP), and three corresponding NC link IDs 748, including first NC link ID 748-a, second NC link ID 748-b, and third NC link ID 748-c.

In other examples, a new element may be provided, in which formats as discussed with reference to FIGS. 7A through 7C remain the same. However, instead of reusing the MLO link information element, a new element (such as, NC MLO link information element) is defined.

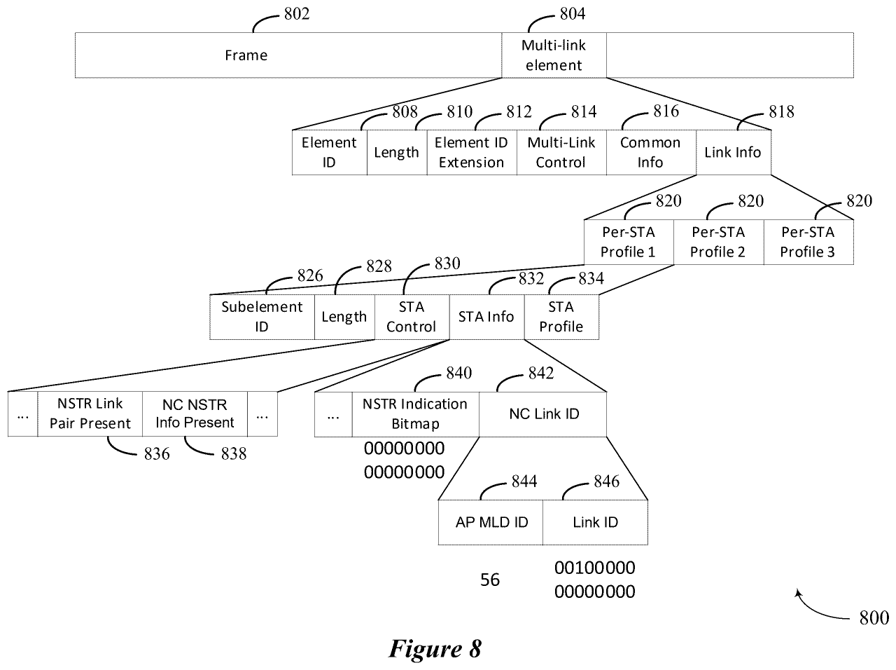

FIG. 8 shows an example of a multi-link element 800 that supports link management for non-collocated multi-link devices. The multi-link element 800 may implement or may be implemented by aspects of the wireless communication network 100, the PPDU 200, or the wireless communication network 300. For example, the multi-link element 800 may be implemented by a non-AP device (such as a wireless device, a non-AP STA, a non-AP MLD) and one or more APs (such as AP MLDs in a DS, an AP STA, an AP MLD), which may be examples of the corresponding devices as described with reference to FIGS. 1 and 3.

In some aspects, a non-AP MLD may indicate its NSTR/STR link status in certain frames, such as in association frames or link reconfiguration request frames where the link status may be indicated via a multi-link element (such as a basic or reconfiguration multi-link element). The indication may signaled on pair-wise basis. For example, assume STA1 operates on link1 and STA2 operates on link2, and assume link1 and link2 form an NSTR link pair for the non-AP MLD. In a per-STA profile of STA1 the bit corresponding to link ID 2 is set to 1 (other bits are set to 0), and in a per-STA profile of STA2 the bit corresponding to link ID 1 is set to 1 (other bits are set to 0).

In the example of FIG. 8, a frame 802 may include a multi-link element 804, which may include an element ID field 808, a length field 810, an element ID extension field 812, a multi-link control field 814, a common information field 816, and a link information field 818. The link information field 818 may include a number of per-STA profile 820, which may include a supplemental ID 826, a length field 828, a STA control field 830, a STA information field 832, and a STA profile field 834. In this example, the STA control field 830 may include a NSTR link pair present field 836 and a NC NSTR information present field 838. The STA information field 832 may include a NSTR indication bitmap 840 and a NC link ID field 842, which may include an AP MLD ID field 844 and a link ID field 846.

In some aspects, link information for NC AP MLDs may be provided in multi-link element 800. In some examples, if the non-AP MLD intends to indicate its NSTR link status for links across different NC AP MLDs, the non-AP may, in a per-STA profile of a STA (say STA1) if another link with the same AP MLD (with which STA1 is associated) is NSTR, then baseline rule is followed. That is, the NSTR indication bitmap 840 has the bit set to 1 for the corresponding link. In the per-STA profile 820 of STA1, if another link with another NC AP MLD is NSTR, then the non-AP MLD includes the NC link ID field 842, which includes the AP MLD ID of the NC AP MLD and the bit corresponding to link to 1 with which STA1's link is NSTR. For example, as illustrated in FIG. 8, the non-AP MLD may request to set up three links out of which STA1 and STA3 are with two different NC AP MLDs. STA1 and STA3 form an NSTR link pair. Further, STA1 and STA2 may be associated with a same AP MLD. The non-AP MLD includes a NC link ID field 842 in the STA information field 832 and sets the bit corresponding to link2 (corresponding to the third bit in the bitmap as illustrated in this example) of AP MLD (with ID 56 in this example) to 1 to indicate that STA1 and STA3 form an NSTR link pair.

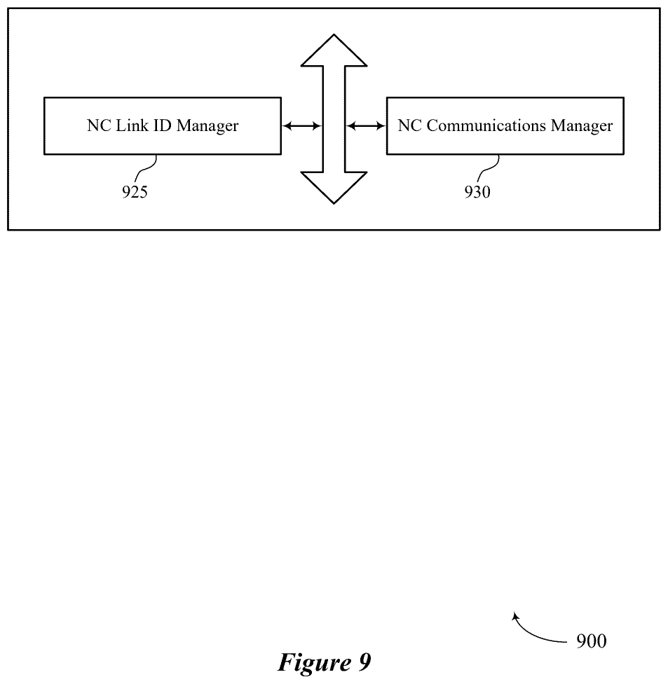

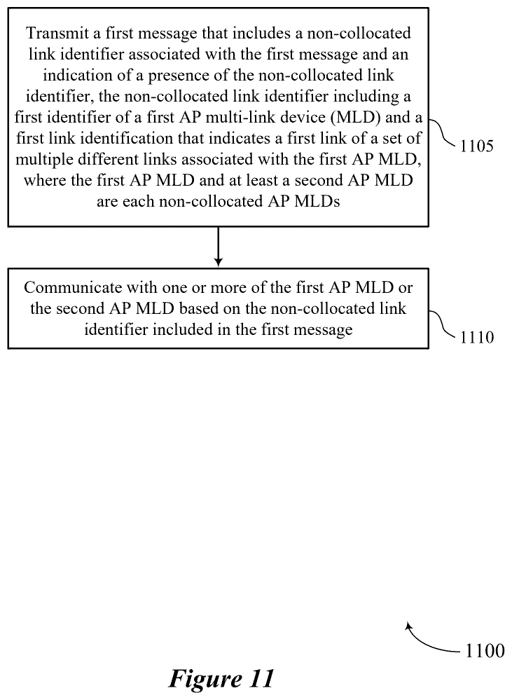

FIG. 9 shows a block diagram of an example wireless communication device 900 that supports link management for non-collocated multi-link devices. In some examples, the wireless communication device 900 is configured to perform the process 1100 described with reference to FIG. 11. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is then passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can be configurable or configured for use in a STA, such as the STA 104 described with reference to FIG. 1. In some other examples, the wireless communication device 900 can be a STA that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes a user interface (UI) (such as a touchscreen or keypad) and a display, which may be integrated with the UI to form a touchscreen display that is coupled with the processing system. In some examples, the wireless communication device 900 may further include one or more sensors such as, for example, one or more inertial sensors, accelerometers, temperature sensors, pressure sensors, or altitude sensors, that are coupled with the processing system.

The wireless communication device 900 includes an NC link ID manager 925 and an NC communications manager 930. Portions of one or more of the NC link ID manager 925 and the NC communications manager 930 may be implemented at least in part in hardware or firmware. For example, one or more of the NC link ID manager 925 and the NC communications manager 930 may be implemented at least in part by at least a processor or a modem. In some examples, portions of one or more of the NC link ID manager 925 and the NC communications manager 930 may be implemented at least in part by a processor and software in the form of processor-executable code stored in memory.

The wireless communication device 900 may support wireless communications in accordance with examples as disclosed herein. The NC link ID manager 925 is configurable or configured to transmit a first message that includes a non-collocated link identifier associated with the first message and an indication of a presence of the non-collocated link identifier, the non-collocated link identifier including a first identifier of a first AP MLD and a first link identification that indicates a first link of a set of multiple different links associated with the first AP MLD, where the first AP MLD and at least a second AP MLD are each non-collocated AP MLDs. The NC communications manager 930 is configurable or configured to communicate with one or more of the first AP MLD or the second AP MLD based on the non-collocated link identifier included in the first message.

In some examples, the non-collocated link identifier includes a first subfield that indicates the first identifier of the first AP MLD, and a second subfield that identifies at least the first link of the set of multiple different links associated with the first AP MLD. In some examples, the second subfield includes a bitmap that indicates one or more links of an AP MLD that is indicated in the first subfield. In some examples, the second subfield includes an indication of a single link of an AP MLD that is indicated in the first subfield. In some examples, one or more non-collocated link identifiers are included with the first message, and the first message further includes an indication of a quantity of the one or more non-collocated link identifiers.

In some examples, the first message is an EMLSR or an EMLMR mode notification message, and the non-collocated link identifier is included in an EML control subfield of the mode notification message. In some examples, EML control subfield includes a first subfield that indicates a presence of the non-collocated link identifier, and a second subfield that includes the non-collocated link identifier. In some examples, the first message is an EMLSR message or an EMLMR message, and the non-collocated link identifier is included in an element in an enhanced multi-link notification frame. In some examples, the first message is a cross-link tunneling message, and the non-collocated link identifier is included in a MLO link information element. In some examples, the first message is a cross-link tunneling message, and the non-collocated link identifier is included in an information element that is different from a MLO link information element. In some examples, the first message is a basic multi-link element associated with a NSTR link, and the non-collocated link identifier is included in a STA information subfield of the multi-link element.

In some examples, the basic multi-link element further includes a STA control subfield that includes an indication that non-collocated NSTR information is present in the basic multi-link element. In some examples, the first message is a traffic indication message associated with the wireless device, and where the non-collocated link identifier is included in a traffic indication message element in a beacon frame, a beacon extension frame, or a management frame. In some examples, the first message is target wake time session setup or transfer message, and where the non-collocated link identifier is included in a target wake time element. In some examples, the first message is power save indication message associated with the wireless device, and where the non-collocated link identifier is included in an aggregate control field of the power save indication message.

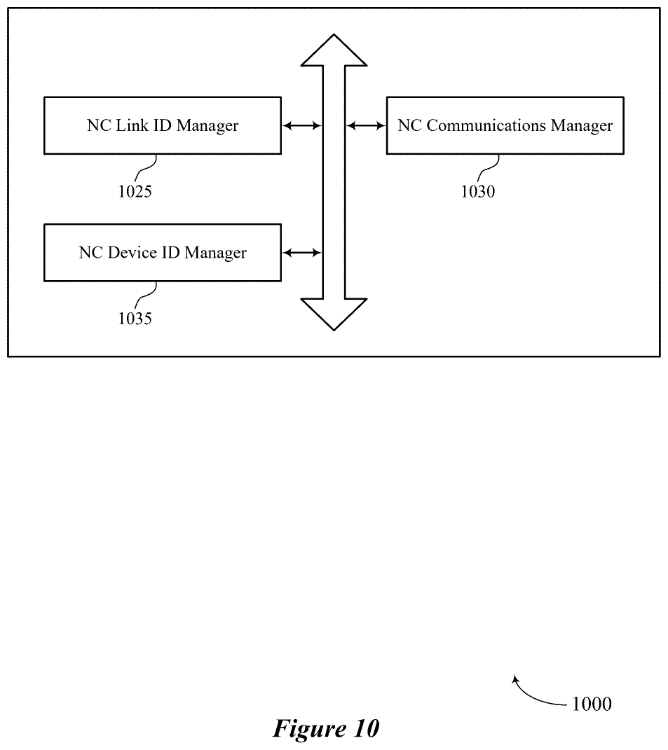

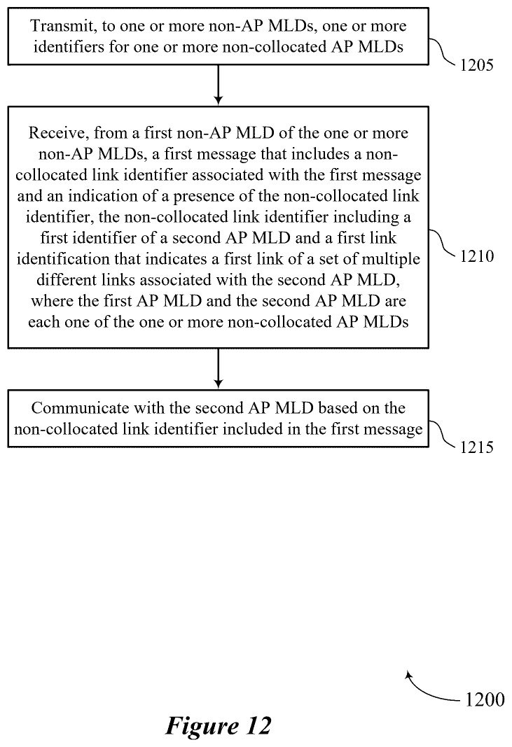

FIG. 10 shows a block diagram of an example wireless communication device 1000 that supports link management for non-collocated multi-link devices. In some examples, the wireless communication device 1000 is configured to perform the processes 1100 and 1200 described with reference to FIGS. 11 and 12, respectively. The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is then passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in an AP, such as the AP 102 described with reference to FIG. 1. In some other examples, the wireless communication device 1000 can be an AP that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes an NC link ID manager 1025, an NC communications manager 1030, and an NC device ID manager 1035. Portions of one or more of the NC link ID manager 1025, the NC communications manager 1030, and the NC device ID manager 1035 may be implemented at least in part in hardware or firmware. For example, one or more of the NC link ID manager 1025, the NC communications manager 1030, and the NC device ID manager 1035 may be implemented at least in part by at least a processor or a modem. In some examples, portions of one or more of the NC link ID manager 1025, the NC communications manager 1030, and the NC device ID manager 1035 may be implemented at least in part by a processor and software in the form of processor-executable code stored in memory.

The wireless communication device 1000 may support wireless communications in accordance with examples as disclosed herein. The NC link ID manager 1025 is configurable or configured to transmit a first message that includes a non-collocated link identifier associated with the first message and an indication of a presence of the non-collocated link identifier, the non-collocated link identifier including a first identifier of a first AP MLD and a first link identification that indicates a first link of a set of multiple different links associated with the first AP MLD, where the first AP MLD and at least a second AP MLD are each non-collocated AP MLDs. The NC communications manager 1030 is configurable or configured to communicate with one or more of the first AP MLD or the second AP MLD based on the non-collocated link identifier included in the first message.

In some examples, the non-collocated link identifier includes a first subfield that indicates the first identifier of the first AP MLD, and a second subfield that identifies at least the first link of the set of multiple different links associated with the first AP MLD. In some examples, the second subfield includes a bitmap that indicates one or more links of an AP MLD that is indicated in the first subfield. In some examples, the second subfield includes an indication of a single link of an AP MLD that is indicated in the first subfield. In some examples, one or more non-collocated link identifiers are included with the first message, and the first message further includes an indication of a quantity of the one or more non-collocated link identifiers.

In some examples, the first message is an EMLSR or an EMLMR mode notification message, and the non-collocated link identifier is included in an EML control subfield of the mode notification message. In some examples, EML control subfield includes a first subfield that indicates a presence of the non-collocated link identifier, and a second subfield that includes the non-collocated link identifier. In some examples, the first message is an EMLSR message or an EMLMR message, and the non-collocated link identifier is included in an element in an enhanced multi-link notification frame.

In some examples, the first message is a cross-link tunneling message, and the non-collocated link identifier is included in a MLO link information element. In some examples, the first message is a cross-link tunneling message, and the non-collocated link identifier is included in an information element that is different from a MLO link information element. In some examples, the first message is a basic multi-link element associated with a NSTR link, and the non-collocated link identifier is included in a STA information subfield of the multi-link element. In some examples, the basic multi-link element further includes a STA control subfield that includes an indication that non-collocated NSTR information is present in the basic multi-link element.

In some examples, the first message is a traffic indication message associated with the wireless device, and where the non-collocated link identifier is included in a traffic indication message element in a beacon frame, a beacon extension frame, or a management frame. In some examples, the first message is target wake time session setup or transfer message, and where the non-collocated link identifier is included in a target wake time element. In some examples, the first message is power save indication message associated with the wireless device, and where the non-collocated link identifier is included in an aggregate control field of the power save indication message.

Additionally, or alternatively, the wireless communication device 1000 may support wireless communications in accordance with examples as disclosed herein. The NC device ID manager 1035 is configurable or configured to transmit, to one or more non-AP MLDs, one or more identifiers for one or more non-collocated AP MLDs. In some examples, the NC link ID manager 1025 is configurable or configured to receive, from a first non-AP MLD of the one or more non-AP MLDs, a first message that includes a non-collocated link identifier associated with the first message and an indication of a presence of the non-collocated link identifier, the non-collocated link identifier including a first identifier of a second AP MLD and a first link identification that indicates a first link of a set of multiple different links associated with the second AP MLD, where the first AP MLD and the second AP MLD are each one of the one or more non-collocated AP MLDs. In some examples, the NC communications manager 1030 is configurable or configured to communicate with the second AP MLD based on the non-collocated link identifier included in the first message.

In some examples, the non-collocated link identifier includes a first subfield that indicates the first identifier of the second AP MLD, and a second subfield that identifies at least the first link of the set of multiple different links associated with the second AP MLD.

In some examples, the second subfield includes a bitmap that indicates one or more links of an AP MLD that is indicated in the first subfield. In some examples, the second subfield includes an indication of a single link of an AP MLD that is indicated in the first subfield. In some examples, one or more non-collocated link identifiers are included with the first message, and the first message further includes an indication of a quantity of the one or more non-collocated link identifiers.

In some examples, the first message is an EMLSR or an EMLMR mode notification message, and the non-collocated link identifier is included in an EML control subfield of the mode notification message. In some examples, the EML control subfield includes a first subfield that indicates a presence of the non-collocated link identifier, and a second subfield that includes the non-collocated link identifier.

In some examples, the first message is an EMLSR message or an EMLMR message, and the non-collocated link identifier is included in an element in an enhanced multi-link notification frame. In some examples, the first message is a cross-link tunneling message, and the non-collocated link identifier is included in a MLO link information element. In some examples, the first message is a cross-link tunneling message, and the non-collocated link identifier is included in an information element that is different from a MLO link information element.

In some examples, the first message is a basic multi-link element associated with a NSTR link, and the non-collocated link identifier is included in a STA information subfield of the multi-link element. In some examples, the basic multi-link element further includes a STA control subfield that includes an indication that non-collocated NSTR information is present in the basic multi-link element.

In some examples, the first message is a traffic indication message associated with the first non-AP MLD, and where the non-collocated link identifier is included in a traffic indication message element in a beacon frame, a beacon extension frame, or a management frame. In some examples, the first message is target wake time session setup or transfer message, and where the non-collocated link identifier is included in a target wake time element. In some examples, the first message is power save indication message associated with the first non-AP MLD, and where the non-collocated link identifier is included in an aggregate control field of the power save indication message.

FIG. 11 shows a flowchart illustrating an example process 1100 performable by or at a wireless device that supports link management for non-collocated multi-link devices. The operations of the process 1100 may be implemented by a wireless device or its components as described herein. For example, the process 1100 may be performed by a wireless communication device, such as the wireless communication device 900 described with reference to FIG. 9, operating as or within a wireless AP or a wireless STA. In some examples, the process 1100 may be performed by a wireless AP or a wireless STA, such as one of the APs 102 or the STAs 104 described with reference to FIG. 1.

In some examples, in 1105, the wireless device may transmit a first message that includes a non-collocated link identifier associated with the first message and an indication of a presence of the non-collocated link identifier, the non-collocated link identifier including a first identifier of a first AP multi-link device (MLD) and a first link identification that indicates a first link of a set of multiple different links associated with the first AP MLD, where the first AP MLD and at least a second AP MLD are each non-collocated AP MLDs. The operations of 1105 may be performed in accordance with examples as disclosed herein. In some implementations, aspects of the operations of 1105 may be performed by an NC link ID manager 925 or an NC link ID manager 1025 as described with reference to FIGS. 9 and 10.

In some examples, in 1110, the wireless device may communicate with one or more of the first AP MLD or the second AP MLD based on the non-collocated link identifier included in the first message. The operations of 1110 may be performed in accordance with examples as disclosed herein. In some implementations, aspects of the operations of 1110 may be performed by an NC communications manager 930 or an NC communications manager 1030 as described with reference to FIGS. 9 and 10.

FIG. 12 shows a flowchart illustrating an example process 1200 performable by or at a first AP multi-link device (MLD) that supports link management for non-collocated multi-link devices. The operations of the process 1200 may be implemented by a first AP multi-link device (MLD) or its components as described herein. For example, the process 1200 may be performed by a wireless communication device, such as the wireless communication device 1000 described with reference to FIG. 10, operating as or within a wireless AP. In some examples, the process 1200 may be performed by a wireless AP, such as one of the APs 102 described with reference to FIG. 1.

In some examples, in 1205, the first AP multi-link device (MLD) may transmit, to one or more non-AP MLDs, one or more identifiers for one or more non-collocated AP MLDs. The operations of 1205 may be performed in accordance with examples as disclosed herein. In some implementations, aspects of the operations of 1205 may be performed by an NC device ID manager 1035 as described with reference to FIG. 10.

In some examples, in 1210, the first AP multi-link device (MLD) may receive, from a first non-AP MLD of the one or more non-AP MLDs, a first message that includes a non-collocated link identifier associated with the first message and an indication of a presence of the non-collocated link identifier, the non-collocated link identifier including a first identifier of a second AP MLD and a first link identification that indicates a first link of a set of multiple different links associated with the second AP MLD, where the first AP MLD and the second AP MLD are each one of the one or more non-collocated AP MLDs. The operations of 1210 may be performed in accordance with examples as disclosed herein. In some implementations, aspects of the operations of 1210 may be performed by an NC link ID manager 1025 as described with reference to FIG. 10.

In some examples, in 1215, the first AP multi-link device (MLD) may communicate with the second AP MLD based on the non-collocated link identifier included in the first message. The operations of 1215 may be performed in accordance with examples as disclosed herein. In some implementations, aspects of the operations of 1215 may be performed by an NC communications manager 1030 as described with reference to FIG. 10.

Implementation examples are described in the following numbered clauses:
Clause 1: A method for wireless communications at a wireless device, comprising: transmitting a first message that includes a non-collocated link identifier associated with the first message and an indication of a presence of the non-collocated link identifier, the non-collocated link identifier including a first identifier of a first AP MLD and a first link identification that indicates a first link of a plurality of different links associated with the first AP MLD, wherein the first AP MLD and at least a second AP MLD are each non-collocated AP MLDs; and communicating with one or more of the first AP MLD or the second AP MLD based at least in part on the non-collocated link identifier included in the first message.
Clause 2: The method of clause 1, wherein the non-collocated link identifier includes a first subfield that indicates the first identifier of the first AP MLD, and a second subfield that identifies at least the first link of the plurality of different links associated with the first AP MLD.
Clause 3: The method of clause 2, wherein the second subfield includes a bitmap that indicates one or more links of an AP MLD that is indicated in the first subfield.
Clause 4: The method of any of clauses 2 through 3, wherein the second subfield includes an indication of a single link of an AP MLD that is indicated in the first subfield.
Clause 5: The method of any of clauses 2 through 4, wherein one or more non-collocated link identifiers are included with the first message, and the first message further includes an indication of a quantity of the one or more non-collocated link identifiers.
Clause 6: The method of any of clauses 1 through 5, wherein the first message is an EMLSR or an EMLMR mode notification message, and the non-collocated link identifier is included in an EML control subfield of the mode notification message.
Clause 7: The method of clause 6, wherein EML control subfield includes a first subfield that indicates a presence of the non-collocated link identifier, and a second subfield that includes the non-collocated link identifier.
Clause 8: The method of clause 1 through 5, wherein the first message is an EMLSR message or an EMLMR message, and the non-collocated link identifier is included in an element in an enhanced multi-link notification frame.
Clause 9: The method of any of clauses 1 through 5, wherein the first message is a cross-link tunneling message, and the non-collocated link identifier is included in a MLO link information element.
Clause 10: The method of any of clauses 1 through 5, wherein the first message is a cross-link tunneling message, and the non-collocated link identifier is included in an information element that is different from a multi-link operation (MLO) link information element.
Clause 11: The method of any of clauses 1 through 5, wherein the first message is a basic multi-link element associated with a non-simultaneous transmit and receive (NSTR) link, and the non-collocated link identifier is included in a STA information subfield of the multi-link element.
Clause 12: The method of clause 11, wherein the basic multi-link element further includes a STA control subfield that includes an indication that non-collocated NSTR information is present in the basic multi-link element.
Clause 13: The method of any of clauses 1 through 5, wherein the first message is a traffic indication message associated with the wireless device, and wherein the non-collocated link identifier is included in a traffic indication message element in a beacon frame, a beacon extension frame, or a management frame.
Clause 14: The method of any of clauses 1 through 5, wherein the first message is target wake time session setup or transfer message, and wherein the non-collocated link identifier is included in a target wake time element.
Clause 15: The method of any of clauses 1 through 5, wherein the first message is power save indication message associated with the wireless device, and wherein the non-collocated link identifier is included in an aggregate control field of the power save indication message.
Clause 16: A method for wireless communications at a first AP MLD, comprising: transmitting, to one or more non-AP MLDs, one or more identifiers for one or more non-collocated AP MLDs; receiving, from a first non-AP MLD of the one or more non-AP MLDs, a first message that includes a non-collocated link identifier associated with the first message and an indication of a presence of the non-collocated link identifier, the non-collocated link identifier including a first identifier of a second AP MLD and a first link identification that indicates a first link of a plurality of different links associated with the second AP MLD, wherein the first AP MLD and the second AP MLD are each one of the one or more non-collocated AP MLDs; and communicating with the second AP MLD based at least in part on the non-collocated link identifier included in the first message.
Clause 17: The method of clause 16, wherein the non-collocated link identifier includes a first subfield that indicates the first identifier of the second AP MLD, and a second subfield that identifies at least the first link of the plurality of different links associated with the second AP MLD.
Clause 18: The method of clause 17, wherein the second subfield includes a bitmap that indicates one or more links of an AP MLD that is indicated in the first subfield.
Clause 19: The method of any of clauses 17 through 18, wherein the second subfield includes an indication of a single link of an AP MLD that is indicated in the first subfield.
Clause 20: The method of any of clauses 17 through 19, wherein one or more non-collocated link identifiers are included with the first message, and the first message further includes an indication of a quantity of the one or more non-collocated link identifiers.
Clause 21: The method of any of clauses 16 through 20, wherein the first message is an EMLSR or an EMLMR mode notification message, and the non-collocated link identifier is included in an enhanced multi-link (EML) control subfield of the mode notification message.
Clause 22: The method of clause 21, wherein the EML control subfield includes a first subfield that indicates a presence of the non-collocated link identifier, and a second subfield that includes the non-collocated link identifier.
Clause 23: The method of any of clauses 16 through 20, wherein the first message is an EMLSR message or an EMLMR message, and the non-collocated link identifier is included in an element in an enhanced multi-link notification frame.
Clause 24: The method of any of clauses 16 through 20, wherein the first message is a cross-link tunneling message, and the non-collocated link identifier is included in a MLO link information element.
Clause 25: The method of any of clauses 16 through 20, wherein the first message is a cross-link tunneling message, and the non-collocated link identifier is included in an information element that is different from a MLO link information element.
Clause 26: The method of any of clauses 16 through 20, wherein the first message is a basic multi-link element associated with a NSTR link, and the non-collocated link identifier is included in a STA information subfield of the multi-link element.
Clause 27: The method of clause 26, wherein the basic multi-link element further includes a STA control subfield that includes an indication that non-collocated NSTR information is present in the basic multi-link element.
Clause 28: The method of any of clauses 16 through 20, wherein the first message is a traffic indication message associated with the first non-AP MLD, and wherein the non-collocated link identifier is included in a traffic indication message element in a beacon frame, a beacon extension frame, or a management frame.
Clause 29: The method of any of clauses 16 through 20, wherein the first message is target wake time session setup or transfer message, and wherein the non-collocated link identifier is included in a target wake time element.
Clause 30: The method of any of clauses 16 through 20, wherein the first message is power save indication message associated with the first non-AP MLD, and wherein the non-collocated link identifier is included in an aggregate control field of the power save indication message.
Clause 31: A wireless device for wireless communications, comprising one or more memories storing processor-executable code, and one or more processors coupled with the one or more memories and individually or collectively operable to execute the code to cause the wireless device to perform a method of any of clauses 1 through 15.
Clause 32: A wireless device for wireless communications, comprising at least one means for performing a method of any of clauses 1 through 15.
Clause 33: A non-transitory computer-readable medium storing code for wireless communications, the code comprising instructions executable by one or more processors to perform a method of any of clauses 1 through 15.
Clause 34: A first AP MLD for wireless communications, comprising one or more memories storing processor-executable code, and one or more processors coupled with the one or more memories and individually or collectively operable to execute the code to cause the first AP MLD to perform a method of any of clauses 16 through 30.
Clause 35: A first AP MLD for wireless communications, comprising at least one means for performing a method of any of clauses 16 through 30.
Clause 36: A non-transitory computer-readable medium storing code for wireless communications, the code comprising instructions executable by one or more processors to perform a method of any of clauses 16 through 30.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless device, comprising:
a processing system that includes processor circuitry and memory circuitry that stores code, the processing system configured to cause the wireless device to:
transmit a first message that includes a non-collocated link identifier associated with the first message and an indication of a presence of the non-collocated link identifier, the non-collocated link identifier including a first identifier of a first access point (AP) multi-link device (MLD) and a first link identification that indicates a first link of a plurality of different links associated with the first AP MLD, wherein the first AP MLD and at least a second AP MLD are each non-collocated AP MLDs; and
communicate with one or more of the first AP MLD or the second AP MLD based at least in part on the non-collocated link identifier included in the first message.

2. The wireless device of claim 1, wherein the non-collocated link identifier includes a first subfield that indicates the first identifier of the first AP MLD, and a second subfield that identifies at least the first link of the plurality of different links associated with the first AP MLD.

3. The wireless device of claim 2, wherein the second subfield includes a bitmap that indicates one or more links of an AP MLD that is indicated in the first subfield.

4. The wireless device of claim 2, wherein one or more non-collocated link identifiers are included with the first message, and the first message further includes an indication of a quantity of the one or more non-collocated link identifiers.

5. The wireless device of claim 1, wherein the first message is an enhanced multi-link single radio (EMLSR) or an enhanced multi-link multi-radio (EMLMR) mode notification message, and the non-collocated link identifier is included in an enhanced multi-link (EML) control subfield of the mode notification message.

6. The wireless device of claim 5, wherein EML control subfield includes a first subfield that indicates a presence of the non-collocated link identifier, and a second subfield that includes the non-collocated link identifier.

7. The wireless device of claim 1, wherein the first message is an enhanced multi-link single radio (EMLSR) message or an enhanced multi-link multi-radio (EMLMR) message, and the non-collocated link identifier is included in an element in an enhanced multi-link notification frame.

8. The wireless device of claim 1, wherein the first message is a cross-link tunneling message, and the non-collocated link identifier is included in a multi-link operation (MLO) link information element.

9. The wireless device of claim 1, wherein the first message is a cross-link tunneling message, and the non-collocated link identifier is included in an information element that is different from a multi-link operation (MLO) link information element.

10. The wireless device of claim 1, wherein the first message is a basic multi-link element associated with a non-simultaneous transmit and receive (NSTR) link, and the non-collocated link identifier is included in a station (STA) information subfield of the multi-link element.

11. The wireless device of claim 10, wherein the basic multi-link element further includes a STA control subfield that includes an indication that non-collocated NSTR information is present in the basic multi-link element.

12. The wireless device of claim 1, wherein the first message is a traffic indication message associated with the wireless device, and wherein the non-collocated link identifier is included in a traffic indication message element in a beacon frame, a beacon extension frame, or a management frame.

13. The wireless device of claim 1, wherein the first message is target wake time session setup or transfer message, and wherein the non-collocated link identifier is included in a target wake time element.

14. The wireless device of claim 1, wherein the first message is power save indication message associated with the wireless device, and wherein the non-collocated link identifier is included in an aggregate control field of the power save indication message.

15. A first access point (AP) multi-link device (MLD), comprising:
a processing system that includes processor circuitry and memory circuitry that stores code, the processing system configured to cause the first AP multi-link device (MLD) to:
transmit, to one or more non-AP MLDs, one or more identifiers for one or more non-collocated AP MLDs;
receive, from a first non-AP MLD of the one or more non-AP MLDs, a first message that includes a non-collocated link identifier associated with the first message and an indication of a presence of the non-collocated link identifier, the non-collocated link identifier including a first identifier of a second AP MLD and a first link identification that indicates a first link of a plurality of different links associated with the second AP MLD, wherein the first AP MLD and the second AP MLD are each one of the one or more non-collocated AP MLDs; and
communicate with the second AP MLD based at least in part on the non-collocated link identifier included in the first message.

16. The first AP multi-link device (MLD) of claim 15, wherein the non-collocated link identifier includes a first subfield that indicates the first identifier of the second AP MLD, and a second subfield that identifies at least the first link of the plurality of different links associated with the second AP MLD.

17. The first AP multi-link device (MLD) of claim 15, wherein the first message is an enhanced multi-link single radio (EMLSR) or an enhanced multi-link multi-radio (EMLMR) mode notification message, and the non-collocated link identifier is included in an enhanced multi-link (EML) control subfield of the mode notification message.

18. The first AP multi-link device (MLD) of claim 15, wherein the first message is an enhanced multi-link single radio (EMLSR) message or an enhanced multi-link multi-radio (EMLMR) message, and the non-collocated link identifier is included in an element in an enhanced multi-link notification frame.

19. The first AP multi-link device (MLD) of claim 15, wherein the first message is a cross-link tunneling message, and the non-collocated link identifier is included in a multi-link operation (MLO) link information element.

20. The first AP multi-link device (MLD) of claim 15, wherein the first message is a cross-link tunneling message, and the non-collocated link identifier is included in an information element that is different from a multi-link operation (MLO) link information element.

21. The first AP multi-link device (MLD) of claim 15, wherein the first message is a basic multi-link element associated with a non-simultaneous transmit and receive (NSTR) link, and the non-collocated link identifier is included in a station (STA) information subfield of the multi-link element.

22. A method for wireless communications at a wireless device, comprising:
transmitting a first message that includes a non-collocated link identifier associated with the first message and an indication of a presence of the non-collocated link identifier, the non-collocated link identifier including a first identifier of a first access point (AP) multi-link device (MLD) and a first link identification that indicates a first link of a plurality of different links associated with the first AP MLD, wherein the first AP MLD and at least a second AP MLD are each non-collocated AP MLDs; and
communicating with one or more of the first AP MLD or the second AP MLD based at least in part on the non-collocated link identifier included in the first message.

23. The method of claim 22, wherein:
the non-collocated link identifier includes a first subfield that indicates the first identifier of the first AP MLD, and a second subfield that identifies at least the first link of the plurality of different links associated with the first AP MLD.

24. The method of claim 22, wherein:
the first message is an enhanced multi-link single radio (EMLSR) or an enhanced multi-link multi-radio (EMLMR) mode notification message, and the non-collocated link identifier is included in an enhanced multi-link (EML) control subfield of the mode notification message.

25. The method of claim 22, wherein:
the first message is an enhanced multi-link single radio (EMLSR) message or an enhanced multi-link multi-radio (EMLMR) message, and the non-collocated link identifier is included in an element in an enhanced multi-link notification frame.

26. A method for wireless communications at a first access point (AP) multi-link device (MLD), comprising:
transmitting, to one or more non-AP MLDs, one or more identifiers for one or more non-collocated AP MLDs;
receiving, from a first non-AP MLD of the one or more non-AP MLDs, a first message that includes a non-collocated link identifier associated with the first message and an indication of a presence of the non-collocated link identifier, the non-collocated link identifier including a first identifier of a second AP MLD and a first link identification that indicates a first link of a plurality of different links associated with the second AP MLD, wherein the first AP MLD and the second AP MLD are each one of the one or more non-collocated AP MLDs; and
communicating with the second AP MLD based at least in part on the non-collocated link identifier included in the first message.

27. The method of claim 26, wherein:
the non-collocated link identifier includes a first subfield that indicates the first identifier of the second AP MLD, and a second subfield that identifies at least the first link of the plurality of different links associated with the second AP MLD.

28. The method of claim 26, wherein:
the first message is a cross-link tunneling message, and the non-collocated link identifier is included in a multi-link operation (MLO) link information element.

29. The method of claim 26, wherein:
the first message is a cross-link tunneling message, and the non-collocated link identifier is included in an information element that is different from a multi-link operation (MLO) link information element.

30. The method of claim 26, wherein:
the first message is a basic multi-link element associated with a non-simultaneous transmit and receive (NSTR) link, and the non-collocated link identifier is included in a station (STA) information subfield of the multi-link element.
